(19) United States
(12) Patent Application Publication
(10) Pub. No.: US 2026/0186908 A1
(43) Pub. Date: Jul. 2, 2026

(54) PUMPING ASSEMBLY, PISTON PUMP AND WATER FLOSSER

(71) Applicant: Glenfly Tech Co., Ltd., Shanghai (CN)

(72) Inventors: Zixin WANG, Shanghai (CN); Lei LI, Shanghai (CN); Yuansheng CHEN, Shanghai (CN)

(21) Appl. No.: 19/361,661

(22) Filed: Oct. 17, 2025

(30) Foreign Application Priority Data
Dec. 31, 2024 (CN) 202411999798.5

(51) Int. Cl. G06F 11/14

(52) U.S. Cl. CPC G06F 11/1441; G06F 2201/805

(57) ABSTRACT

The present disclosure relates to a method and system for data retention during power gating. The method includes: sending a power-off request to a shut-off module, the power-off request being configured to instruct the shut-off module to return to-be-stored data; receiving a data saving request sent by each shut-off module, and centrally storing the to-be-stored data carried by each data saving request in a first retention memory; and in response to receiving a data restore signal, returning data stored in the first retention memory to a corresponding shut-off module. The data restore signal is generated after the shut-off module is powered on again.

### CROSS-REFERENCE TO RELATED APPLICATIONS

The present application claims priority to Chinese patent application No. 2024119997985, filed on December 31, 2024, the entire content of which is incorporated herein by reference.

### TECHNICAL FIELD

The present disclosure relates to the field of chip technologies, and in particular, to a method and system for data retention during power gating.

### BACKGROUND

In contemporary chip power consumption analysis, the importance of static power consumption is increasing day by day. As process technologies advance into the nanometer scale, the threshold voltages of transistors decrease while gate-level oxide layers are thinner, and the static power consumption is gradually approaching or even surpassing the dynamic power consumption. This has become an issue as important as dynamic power consumption.

Therefore, in the present low-power design, the processing of static power consumption accounts for an increasingly large proportion. Power gating is always a conventional solution for optimizing static power consumption. Power gating means powering off the entire module. In the present design, many power gating solutions have achieved hardware automation, which is not easy for software and drivers to perceive. This power gating solution is often that the hardware determines that the module is in a completely idle state for a period of time (sometimes supplemented by some flag signals), and then the module will enter the power-off state. At this time, if a scenario similar to the following example occurs, the task will fail due to data loss:

1. Register context reuse. There is a time interval between the two tasks sent by the software and some register contexts are reused, and the software will not perform a complete register configuration again before the second task starts.

2. Data dependency. The next task needs to use some data generated during the previous task.

Then a retention mechanism is needed to save the data before the module loses power and wait for quick restore after the next power-on.

In order to store the to-be-retained data after power-off process in a register with a retention function or in a static random access memory (SRAM) with a deep sleep mode, the module can use an additional low-voltage power supply to retain the data without losing it when the power is off, and the retained data can be restored for normal functional logic after the module is powered on again.

This solution usually requires an additional always-on power supply as an independent low-voltage retention power supply. The main purpose of this power supply is to retain necessary data when the normal operating voltage of the module is turned off, but it will not participate in data transmission. At the same time, conventional solutions such as the above are usually implemented with the help of retention registers (retention flipflop) or static random access memory. From a spatial perspective, these are local processing, i.e., additional always-on retention cells will be attached to the storage cells that need to retain data within the power-off domain. In addition to the function of storing data in general storage cells, these retention cells also provide a set of control signal ports for retention restore, so that the data can be saved in a retention circuit before the module is powered off, and then be recovered after being powered up.

However, conventional methods require an additional low-voltage retention power supply, which increases the cost of off-chip power supply design implementation. At the same time, the additional always-on low-voltage power supply increases the complexity of the back-end implementation of on-chip power supply network, which may extend the implementation cycle and increase design risks.

In addition, because the retention cells are scattered inside the module, when the module is powered off and the data are retained in the retention cells, special attention must be paid to the isolation analysis and processing between the shut-off part of the module and the retention cells to avoid external power-off process from destroying the retained data. Therefore, in fact, a sub power domain is introduced within a power domain that will not be powered off relative to the power domain, which undoubtedly increases the complexity of low power implementation.

### SUMMARY

A method and system for data retention during power gating is provided, which can avoid adding an additional power supply and reduce the complexity of low power consumption implementation in order to address the above technical problems.

In a first aspect, a method for data retention during power gating is provided in the present disclosure, which is applied to an always-on power management unit, and the method includes:

sending a power-off request to a shut-off module, the power-off request being configured to instruct the shut-off module to return to-be-stored data;

receiving a data saving request sent by each shut-off module, and centrally storing the to-be-stored data carried by each data saving request in a first retention memory; and

in response to receiving a data restore signal, returning data stored in the first retention memory to a corresponding shut-off module, the data restore signal being generated after the shut-off module is powered on again.

In an embodiment, the method further includes:

on a condition that a chip is powered on and reset, entering a first default state; and

in the first default state, only receiving the data saving request sent by the shut-off module, and ignoring the data restore signal.

In an embodiment, receiving the data saving request sent by each shut-off module, and centrally storing the to-be-stored data carried by each data saving request in the first retention memory includes:

receiving the data saving request sent by the shut-off module, and determining whether the data saving request is a last transmission request;

in response to determining that the data saving request is the last transmission request, centrally storing the to-be-stored data carried by the data saving request in the first retention memory, and entering a preparation state, in the preparation state, the always-on power management unit being configured to wait for the data restore signal.; and

in response to determining that the data saving request is not the last transmission request, centrally storing the to-be-stored data carried by the data saving request in the first retention memory, entering a first saving state, and continuing to receive a next data saving request sent by the shut-off module, until a data saving request is the last transmission request, and then entering the preparation state, in the first saving state, the always-on power management unit being configured to receive data saving request sent by the shut-off module.

In an embodiment, in response to receiving the data restore signal, returning the data stored in the first retention memory to the corresponding shut-off module includes:

in response to receiving the data restore signal and being in a preparation state, and data returned to the shut-off module not being last data, returning the stored data to the corresponding shut-off module; and

in response to receiving the data restore signal and being in a preparation state, and data returned to the shut-off module being last data, entering a first default state.

The method further includes, in response to receiving the data restore signal and being in the first default state, ignoring the data restore signal.

In a second aspect, a method for data retention during power gating is further provided in the present disclosure, which is applied to a shut-off module, and the method includes:

receiving a power-off request sent by an always-on power management unit;

determining to-be-stored data based on the power-off request, generating a data saving request based on the to-be-stored data, and sending the data saving request to the always-on power management unit, the data saving request being configured to instruct the always-on power management unit to centrally store the to-be-stored data in a first retention memory;

in response to powering on again, receiving data sent by the always-on power management unit, the data being sent by the always-on power management unit in response to receiving a data restore signal.

In an embodiment, after receiving the power-off request sent by the always-on power management unit, the method further includes:

entering a saving judgement state and determining whether it is necessary to store the to-be-stored data in the always-on power management unit before powering off;

on a condition that it is not necessary to store the to-be-stored data in the always-on power management unit, jumping to a second default state, in the second default state, the power-off module being configured to receive the power-off request sent by the always-on power management unit; and

on a condition that the to-be-stored data need to be stored in the always-on power management unit, jumping to the second saving state.

Determining the to-be-stored data based on the power-off request includes, in the second saving state, determining the to-be-stored data.

In an embodiment, the method further includes:

on a condition that the shut-off module operates normally, storing intermediate data generated by the shut-off module in a local second retention memory, and reading stored intermediate data from the second retention memory and processing the intermediate data.

A system for data retention during power gating is provided in the present disclosure. The system includes: an always-on power management unit and at least one shut-off module.

The always-on power management unit is configured to implement the above-mentioned method for data retention during power gating, and the method includes:

sending a power-off request to a shut-off module, wherein the power-off request is configured to instruct the shut-off module to return to-be-stored data;

receiving a data saving request sent by each shut-off module, and centrally storing the to-be-stored data carried by each data saving request in a first retention memory; and

in response to receiving a data restore signal, returning data stored in the first retention memory to a corresponding shut-off module, wherein the data restore signal is generated after the shut-off module is powered on again.

In an embodiment, the always-on power management unit includes:

a first retention memory configured to centrally store the to-be-stored data sent by each shut-off module; and

a first retention control unit configured to store the to-be-stored data sent by each shut-off module in the first retention memory, read data from the first retention memory, and transmit the read data to a corresponding powered-on shut-off module.

In an embodiment, the first retention memory includes a first register and a first SRAM, the first register is a non-retention register, and the first SRAM is a non-low-power consumption SRAM.

In one of the embodiments, the always-on power management unit includes a local clock, which is a working clock of the first retention memory and the first retention control unit, and the local clock is turned off on a condition that there is no storage of to-be-stored data and data restore.

In an embodiment, the shut-off module includes:

a normal operation unit configured to control normal operation of the shut-off module; and

a second retention control unit, including a second retention memory, configured to store the to-be-stored data generated by the normal operation unit on a condition that the shut-off module operates normally, and provide data stored in the second retention memory for the normal operation unit to read.

The second retention control unit is further configured to establish a communication path with the first retention control unit, and store and read the to-be-stored data via the communication path.

In an embodiment, the communication path includes at least one of an existing setup path and a retention path. the existing setup path is an existing path for configuring configuration information of the shut-off module. The retention path is configured to:

send a power-off preparation request sent by the first retention control unit to the second retention control unit;

in the process of storing to-be-stored data, send the to-be-stored data sent by the second retention control unit to the first retention control unit; and

in the process of data restore, send the data sent by the first retention control unit to the second retention control unit.

In an embodiment, the retention path is an asynchronous transmission path.

In an embodiment, the second retention memory includes a second register and a second SRAM, the second register is a non-retention register, and the second SRAM is a non-low-power consumption SRAM.

According to the above-mentioned method and system for data retention during power gating, a power-off request is sent to a shut-off module, and the power-off request is configured to instruct the shut-off module to return to-be-stored data. A data saving request sent by each shut-off module are received, and the to-be-stored data carried by each data saving request are centrally stored in a first retention memory. In response to receiving a data restore signal, the stored data are returned to corresponding shut-off module during the data restore process. The always-on power management unit is an existing module, and there is no need to add an additional always-on low-voltage retention power supply for power-off retention of data, which saves the cost of the power supply module and reduces the complexity of the back-end power supply network, thereby reducing the design risk and shortening the design implementation cycle of the product. In the present disclosure, the data of each shut-off module are centrally stored in the first retention memory, which avoids introducing additional always-on sub-voltage domain (sub power domain introduced by retention). This means that there is no need to perform additional isolation analysis and processing within a single voltage domain, which reduces the complexity of low-power implementation and verification. This simplified low-power solution will reduce the risk of system problems and also reduce the overall cycle of chip design implementation and verification.

### BRIEF DESCRIPTION OF THE DRAWINGS

In order to describe the technical solutions in the embodiments of the present disclosure or the conventional technology more clearly, the following will briefly introduce the accompanying drawings required for describing the embodiments or the conventional technology. Apparently, the accompanying drawings in the following description are merely embodiments of the present disclosure, and for a person of ordinary skill in the art, other drawings can be obtained based on the disclosed drawings without creative efforts.

FIG. 1 is a schematic diagram of a structure of a system for data retention during power gating in an embodiment.

FIG. 2 is a schematic flowchart of a method for data retention during power gating in an embodiment.

FIG. 3 is schematic diagram of controlling a state machine of an always-on power management unit in an embodiment.

FIG. 4 is a schematic flowchart of a method for data retention during power gating in another embodiment.

FIG. 5 is a schematic diagram of controlling a state machine of a shut-off module in an embodiment.

### DETAILED DESCRIPTION OF THE EMBODIMENTS

In order to make the purposes, technical solutions and advantages of the present disclosure more clearly understood, the present disclosure is further described in detail below in conjunction with the accompanying drawings and embodiments. It should be understood that the specific embodiments described herein are only used to explain the present disclosure and are not used to limit the present disclosure.

A system for data retention during power gating is provided in an embodiment of the present disclosure, which includes: an always-on power management unit and at least one shut-off module. The shut-off module allows to be shut off.

The always-on power management unit is an existing always-on module in a chip, usually a power supply module or a clock control module. The always-on power management unit is configured to perform a method for data retention during power gating to centrally store data of different shut-off modules, thereby avoiding the need for an additional power supply.

The always-on power management unit can save retention data of each shut-off module, i.e., all retention data are centrally managed in the always-on power management unit, so that the retention data from as many shut-off modules as possible that are turned on or off synchronously can be packaged into a few the SRAMs of a first retention memory, which is convenient for power consumption management and area optimization of this part of the circuit.

No retention cell is retained inside each shut-off module, so each shut-off module can be completely shut off as a whole, without having to pay attention to the local isolation processing within the module, thereby simplifying the power domain configuration of a single module and the low-power strategy configuration within the module, reducing the complexity of low-power verification, simulation and implementation.

In some optional embodiments, the always-on power management unit includes a first retention memory and a first retention control unit. The first retention memory is configured to centrally store to-be-stored data sent by each shut-off module. The first retention control unit is configured to store the to-be-stored data sent by each shut-off module in the first retention memory, read data from the first retention memory, and transmit the read data to a corresponding powered-on shut-off module.

The always-on power management unit PMU is configured to manage power consumption-related matters and is a module that is never shut off. In addition to the normal logic part for working, it further includes a first retention memory and a first retention control unit.

The first retention memory is configured to centrally store to-be-retained data of all the shut-off parts. The first retention memory may include a plurality of SRAMs (Static Random-Access Memory) and a plurality of registers.

Because the area of retention registers is usually about 20% to 50% larger than that of common registers, the area of SRAM with retention function will generally increase by about 5% to 10% compared to the same common SRAM. In some optional embodiments, the first retention memory includes a first register and a first SRAM. The first register is a non-retention register, and the first SRAM is a non-low-power consumption SRAM. The non-retention register is a common register, and the first SRAM is also a common SRAM.

The first retention control unit, specifically a PMU retention control module, is configured to process the retention transmission logic (including storage logic and restore logic) through the shut-off module, specifically a PSO module, and configured to save the to-be-retained data sent by the shut-off module in the first retention memory for data retention, read data from the first retention memory, and transmit it to the shut-off module for data restore.

In some optional embodiments, the always-on power management unit includes a local clock, which is a working clock of the first retention memory and the first retention control unit, and the local clock is turned off when there is no storage of to-be-stored data and data restore.

In the above embodiment, by adding clock gating to the always-on power management unit locally, the clock related to the retention logic is turned off when data storage and data restore are not required, thereby further reducing dynamic power consumption.

In some optional embodiments, the shut-off module includes a normal operation unit and a second retention control unit.

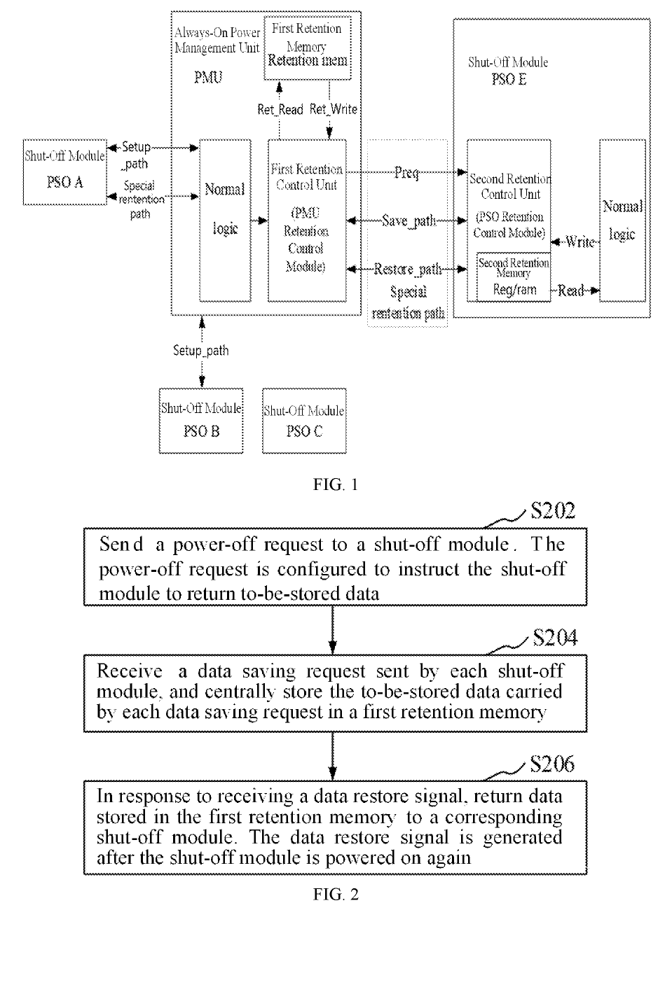

FIG. 1 is a schematic diagram of four types of shut-off modules. The shut-off module PSO E shows a transmission structure of a current special retention path, and the other shut-off modules PSO are configured to illustrate possible application scenarios of the retention path.

The normal operation unit is configured to control normal operation of the shut-off module. For example, its operation before the shut-off module is powered off, which is not specifically limited here.

The second retention control unit includes a second retention memory, which is configured to store the to-be-stored data generated by the normal operation unit on a condition that the shut-off module operates normally, and is configured to provide data stored in the second retention memory for the normal operation unit to read. The second retention control unit is further configured to establish a communication path with the first retention control unit, and store and read the to-be-stored data via the communication path.

On a condition that the shut-off module operates normally, intermediate data generated during operating can be stored in the second retention memory to facilitate data retention during power-on and power-off. During normal operation, if intermediate data are required, the data can be read directly from this part. One point that needs to be explained is that the second retention control unit can also determine whether the shut-off module needs to save data when the power is off based on whether valid data are stored in the second retention memory, i.e., to perform data retention. In the case where valid data are stored, it is determined that the data need to be saved. Otherwise, it is determined that the data does not need to be saved.

On a condition that the shut-off module needs to retain data, the second retention control unit sends the to-be-stored data in the second retention memory to the always-on power management unit for data retention. After the shut-off module is powered on, the second retention control unit receives the data sent by the always-on power management unit for data restore.

To facilitate understanding, the above-mentioned transmission signals are described with reference to FIG. 1.

In the always-on power management unit, data are read from the first retention memory, specifically a Retention mem, via the Ret_Read path and is sent to the first retention control unit, specifically the PMU retention control module, for transmission.

The Ret_Write path is a path used by the first retention control unit, specifically the PMU retention control module, to store the data obtained from the shut-off module PSO in the first retention memory, specifically the Retention mem.

The above-mentioned Ret_Read path and Ret_Write path are both standard handshake communications.

In the shut-off module PSO E, the Write path includes the normal register setup path of the shut-off module, and further includes the storage path for intermediate data requiring retention or restore processing. Through this, the hardware such as the shut-off module will directly store all data requiring retention and restore processing in the second retention memory specifically register or RAM sections of a second retention control unit, specifically a PSO retention control module, during normal operation.

The Read path is a path for obtaining required information when the shut-off module PSO operates normally.

In the implementation, based on the clock condition of the entire module, the Write path and the Read path can adopt at least one of the two modes of direct transmission and handshake transmission.

The special retention path between the always-on power management unit and the shut-off module is generally implemented with the help of four-phase asynchronous handshakes or two-phase asynchronous handshakes with an even number of transmissions. A path data bandwidth is generally selected as an integer multiple of a physical register bit width. Preq is a power-off preparation request sent by the always-on power management unit PMU to the shut-off module PSO, which notifies the shut-off module PSO to start the save process. Save_path is a storage data path of the special retention path, which is initiated by the shut-off module PSO and responded by the always-on power management unit PMU. Restore_path is a restore data path of the special retention path, which is initiated by the always-on power management unit PMU and responded to by the shut off module PSO.

In some optional embodiments, the communication path includes at least one of an existing setup path and a retention path. The existing setup path is an existing path for configuring configuration information of the shut-off module. The retention path is configured to send a power-off preparation request sent by a first retention control unit to a second retention control unit, send the to-be-stored data sent by the second retention control unit to the first retention control unit in the process of storing to-be-stored data, and in the process of data restore, send the data sent by the first retention control unit to the second retention control unit.

With reference to FIG. 1, there are two types of paths between the shut-off module and the always-on power management unit. One is an existing setup path, and the other is the retention path, specifically a Special Retention Path. Both paths can be used to retain data of the shut-off module. Optionally, the communication path includes at least one of an existing setup path and a retention path, and the data retention and restore requirements of all the shut-off modules can be met through the cooperation of the two types of paths. With reference to FIG. 1, not all shut-off modules require both paths. Some shut-off modules do not require data retention at all, and therefore do not need to establish a communication path with the always-on power management unit, such as the shut-off module PSO C in FIG. 1.

It is to be noted that many modules in the chip already have register setup paths that are used to configure the operational context of the module and read information such as the operation state of the module. The readability and writability of setup path can easily meet the data retention and restore requirements of the module's configuration registers. This requirement is mainly because some configuration registers will not be reconfigured on the driver side or software side, so when the module hardware is powered off autonomously (not relying on the software driver), it is also necessary to automatically retain the data. This path reuses the existing setup path, avoiding additional logic overhead. However, this path has certain limitations, and it cannot fully access all the registers of the module. Therefore, In the embodiment, an additional special retention path is added to provide a retention and restore function for the remaining storage parts except the configuration registers.

In some optional embodiments, the retention path is an asynchronous transmission path.

In some optional embodiments, the second retention memory includes a second register and a second SRAM. The second register is a non-retention register, and the second SRAM is a non-low-power consumption SRAM.

The storage module section (including the first retention memory and the second retention memory) in the present disclosure will inevitably introduce additional gate counts, because it finds another space in the always-on power management unit to store the data originally in the shut-off module. However, the registers in the original shut-off module that require to retain power-off data are retention registers, which usually increase the area of common registers by about 20% to 50%. At the same time, SRAM with retention function will generally increase the area by about 5% to 10% relative to a common SRAM. In view of this, the present disclosure has made the following optimization adjustments in terms of the number of gates or power consumption of the storage module:

First, the retention registers in the shut-off module are converted back to common registers, and the SRAM that supports low-power control is converted back to common SRAM, thereby reducing the area overhead of this part of the shut-off module.

Common SRAM and registers are directly used in the always-on power management unit PMU to store to-be-retained data when the shut-off module is powered off, and there is no need to use devices that support low power consumption functions.

The data in the registers or SRAMs that are turned on and off at the same time are packaged into a single common SRAM for unified storage. When the amount of to-be-stored data are large, the single SRAM will have a smaller area than a configuration of multiple discrete SRAMs and registers.

The always-on power management unit PMU does not have high performance requirements, and the retention path uses asynchronous transmission implementation, so the always-on power management unit PMU can operate at a lower clock frequency and voltage as a whole. The lower operating frequency will allow for a physical unit with a smaller area, ultimately reducing the area and cutting down power consumption.

Finally, by adding clock gating to the always-on power management unit PMU, the clock related to the retention and restore logic can be turned off when storage and restore are not required, further reducing dynamic power consumption.

In some optional embodiments, a chip is further provided in the present disclosure, including the above-mentioned power gating system for data retention.

In the above embodiment, the data inside the shut-off module can be efficiently stored in an always-on module, thereby avoiding many complex low-power implementation details. The shut-off module is given the ability to independently choose whether to store, and at the same time, a first retention control unit in the PMU can also automatically filter out unnecessary redundant or invalid restore operations to save power-on and power-off preparation time. These two points together make the present disclosure well adapted to various chip application scenarios, and regardless of whether the shut-off module needs to perform saving or restoring, or whether it will dynamically decide whether to perform saving or restoring based on the present task configuration, it can be perfectly adapted.

It’s not necessary to add an additional always-on low-voltage retention power supply for data power-off retention in the present disclosure, which saves the cost of the power supply module and reduces the complexity of the back-end power supply network, thereby reducing the design risk and shortening the design implementation cycle of the product.

In addition, the present disclosure avoids the situation where an additional always-on sub-power domain is introduced by retention into a power domain, which means that there is no need to perform additional isolation analysis and processing within a single power domain, reducing the complexity of low-power implementation and verification. This simplified low-power solution will reduce the risk of system problems and can also reduce the overall cycle of chip design implementation and verification.

Third, the special retention path design in the present disclosure can be adapted to almost all application scenarios, and can easily help designers avoid all invalid or redundant saving and restoring actions, providing a highly efficient retention function.

Fourth, the present disclosure also optimizes the area and power consumption of the storage section from multiple aspects, so that the impact of the present disclosure on the chip area is reduced to an extremely low level.

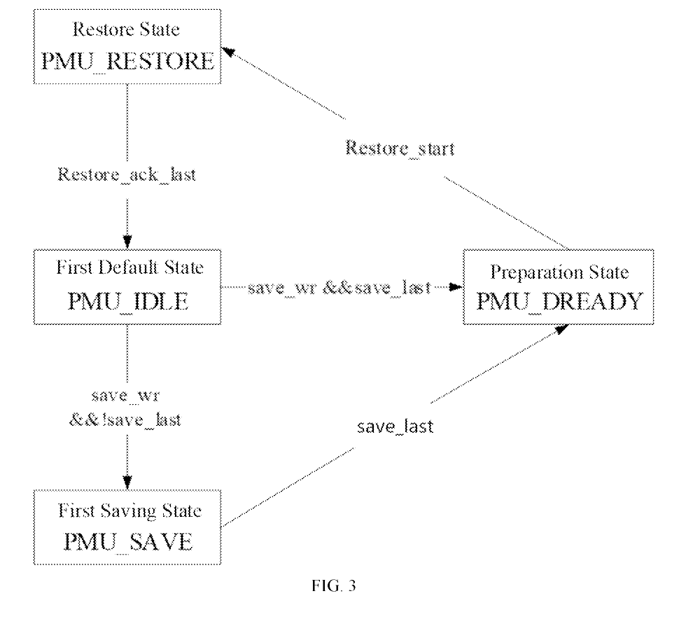

In an exemplary embodiment, as shown in FIG. 2, a method for data retention during power gating is provided, Taking the method applied to the always-on power management unit in FIG. 1 as an example, the method includes the following steps S202 to S206.

In step S202, a power-off request is sent to a shut-off module. The power-off request is configured to instruct the shut-off module to return to-be-stored data.

Before each shut-off module is ready to power off after running for a period of time, the always-on power management unit sends the power-off request to the corresponding shut-off module, so that the shut-off module can determine whether to perform the data retention process based on the power-off request, i.e., whether there are to-be-stored data, and whether the to-be-stored data need to be sent to the always-on power management unit for storage.

In other embodiments, an always-on power management unit can provide power to each shut-off module.

In step S204, a data saving request sent by each shut-off module is received, and the to-be-stored data carried by each data saving request are centrally stored in a first retention memory.

The always-on power management unit is in the first default state IDLE, i.e., the idle state, after the system is started, which means that there is no data that needs to be restored at this time, and the always-on power management unit is waiting for a new data saving request from the shut-off module. After the always-on power management unit sends a power-off request to the shut-off module, if there are to-be-stored data that needs to be saved, the shut-off module sends a data saving request to the always-on power management unit.

It should be noted that since the number relationship between the always-on power management units and the shut-off modules is a one-to-many relationship, and the design allows the turning on and off times of multiple shut-off modules to overlap, i.e., they are supported to be powered on and off independently, the always-on power management unit and each shut-off module in the present disclosure are designed to communicate asynchronously and not interfere with each other.

After receiving the data saving request sent by the shut-off module, the always-on power management unit saves the to-be-stored data carried by the data saving request in the first retention memory. Optionally, each shut-off module shares a first retention memory, i.e., the to-be-stored data in the first retention memory of each shut-off module are stored continuously, and can be indexed by a shut-off module identifier.

In step S206, in response to receiving a data restore signal, data stored in the first retention memory are returned to a corresponding shut-off module. The data restore signal is generated after the shut-off module is powered on again.

The data restore signal is generated by the always-on power management unit. When the shut-off module needs to be awakened again, the always-on power management unit PMU will first restore the power, clock, isolation, reset and other states of the shut-off module to normal. Then the always-on power management unit PMU will receive a data restore signal, denoted as restore_start, from itself. The data restore signal indicates that the shut-off module is ready and can start to determine whether to restore data to the shut-off module.

In the case where it is determined that the shut-off module can perform data restore, the corresponding shut-off module returns the data stored in the first retention memory, so that the shut-off module can operate normally after being powered on.

The always-on power management unit in the above-mentioned data retention method during power gating is an existing module, and there is no need to add an additional always-on low-voltage retention power supply for power-off retention of data, which saves the cost of the power supply module and reduces the complexity of the back-end power supply network, thereby reducing the design risk and shortening the design implementation cycle of the product. In the present disclosure, the data of each turn-off module are centrally stored in the first retention memory, which avoids introducing additional always-on sub-voltage domain (sub power domain introduced by retention). This means that there is no need to perform additional isolation analysis and processing within a single voltage domain, which reduces the complexity of low-power implementation and verification. This simplified low-power solution will reduce the risk of system problems and also reduce the overall cycle of chip design implementation and verification.

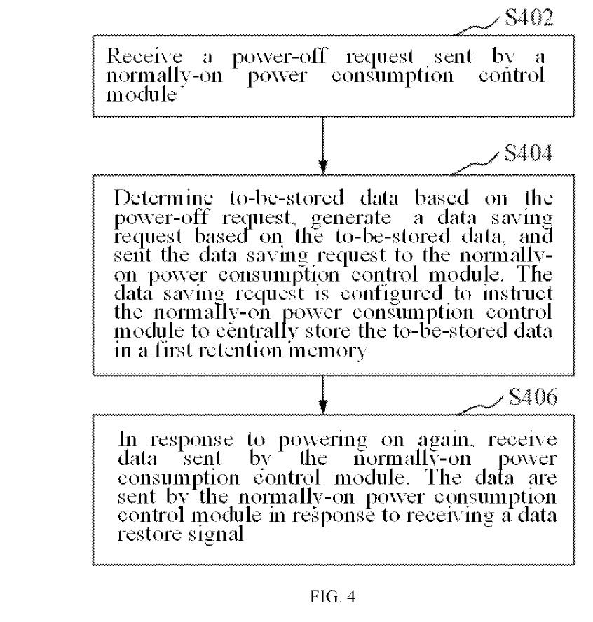

To facilitate understanding, referring to FIG. 3, which is a schematic diagram of controlling a state machine of an always-on power management unit in an embodiment, the always-on power management unit includes a first default state IDLE, a first saving state, a restore state, and a preparation state.

In some optional embodiments, the method further includes: on a condition that the chip is powered on and reset, a first default state IDLE is entered, and in the first default state IDLE, only to-be-stored data in the shut-off module are received and a data restore signal is ignored.

In the first default state IDLE, the always-on power management unit PMU can only respond to the data saving request, i.e., receive the to-be-stored data, and automatically ignore or skip the data restore signal.

For example, after the chip is powered on and reset, the always-on power management unit PMU is in the first default state IDLE. For the shut-off module where the chip defaults to shut off after the chip is started, since it is actually the first time to be powered on, the always-on power management unit PMU will automatically skip this meaningless restore process. In the subsequent processing, the always-on power management unit PMU is in the first default state IDLE, and only receives the to-be-stored data of the corresponding shut-off modules, while ignoring the data restore signals of the shut-off modules.

In some optional embodiments, receiving the data saving request sent by each shut-off module, and storing the to-be-stored data carried by each data saving request in a first retention memory includes:

receiving the data saving request sent by the shut-off module, and determining whether the data saving request is a last transmission request;

in response to determining that the data saving request is the last transmission request, centrally storing the to-be-stored data carried by the data saving request in the first retention memory, and entering a preparation state, where in the preparation state, the always-on power management unit is configured to wait for the data restore signal;

in response to determining that the data saving request is not the last transmission request, centrally storing the to-be-stored data carried by the data saving request in the first retention memory, entering a first saving state, where in the first saving state, the always-on power management unit is configured to receive the data saving request sent by the shut-off module; and

repeating the step of receiving a data saving request sent by the shut-off module until a current data saving request is the last transmission request, and then entering the preparation state.

In the first default state IDLE, when the first data saving request arrives, if the data saving request is also the last data saving request required by the shut-off module during this power-off process, i.e., save_last ==1 at this time, the always-on power management unit PMU will jump from the first default state IDLE to a preparation state DREADY, otherwise it will jump from the first default state IDLE to the first saving state SAVE.

The first saving state SAVE is the state of the always-on power management unit when the shut-off module sends multiple data saving requests to the always-on power management unit. That is to say, the first saving state SAVE is a state in which multiple data saving requests are being processed, indicating that multiple consecutive data saving requests sent by the shut-off module in a single power-off preparation are being processed.

In the first saving state SAVE, a data saving request sent by the shut-off module can be received. When the last data saving request (not the first) of the shut-off module is received by the always-on power management unit PMU, the always-on power management unit PMU jumps to the preparation state DREADY.

In some optional embodiments, the method for determining whether it is the last data saving request includes at least one of the following steps.

The shut-off module directly sends the last flag information (the last data saving request identifier) to the always-on power management unit PMU. The last flag information is generated by the shut-off module.

The always-on power management unit PMU generates data internally, and in this method, the always-on power management unit PMU and the shut-off module need to predefine the number of data storage requests for each fixed transmission.

In some optional embodiments, in response to receiving the data restore signal, returning the stored data to the corresponding shut-off module, includes: in response to receiving the data restore signal and being in a preparation state, and data returned to the shut-off module not being last data, returning the stored data to the corresponding shut-off module; and in response to receiving the data restore signal and being in a preparation state, and data returned to the shut-off module being last data, entering a first default state IDLE. The above method further includes: in response to receiving the data restore signal and being in the first default state, ignoring the data restore signal.

The preparation state is a state in which the data of the shut-off module has been stored. Then, in response to receiving a power-on trigger signal of the shut-off module, the always-on power management unit PMU will automatically jump to the restore state to start the data restore process.

The restore state is a state in which the always-on power management unit PMU is performing data restore for the shut-off module. The last data restore request will generate a restore_last flag by the always-on power management unit PMU. The restore_last flag is configured to indicate that it is the last restored data, and the restore_last flag cooperates with the response returned by the shut-off module to finally generate the restore_ack_last signal in FIG. 3. The restore_ack_last signal indicates that the last data restore request has been responded to by the shut-off module, thereby triggering the state of the special retention path to jump to the first default state IDLE, and start waiting for the data saving request when the shut-off module is powered off next time.

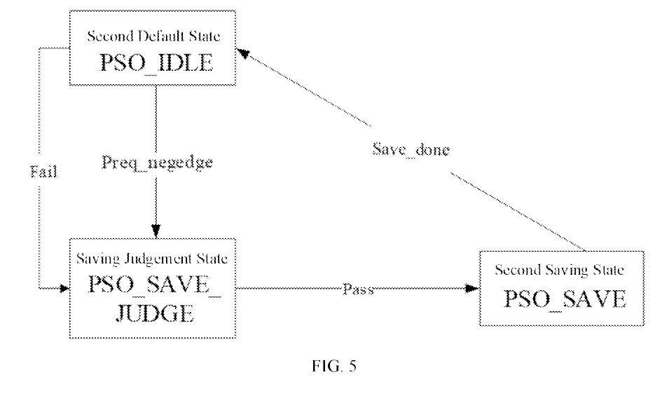

In an exemplary embodiment, as shown in FIG. 4, a method for data retention during power gating is provided. The method is described by taking the method applied to the shut-off module in FIG. 1 as an example, and includes the following steps S402 to S406.

In step S402, a power-off request sent by an always-on power management unit is received.

In step S404, to-be-stored data are determined based on the power-off request, a data saving request is generated based on the to-be-stored data, and the data saving request is sent to the always-on power management unit. The data saving request is configured to instruct the always-on power management unit to centrally store the to-be-stored data in a first retention memory.

The specific limitations on power-off requests can be found above. In the power-off module PSO, it is necessary to add interface logic with a controller for all registers and SRAMs that need to be retained after being powered off. The method adopted in the present disclosure is to put these registers and SRAMs in the power-off module into a sub-module, specifically a register or RAM, for unified management during design, and place this sub-module inside the second retention control unit, specifically the PSO retention control module, to facilitate retention and restore operations. A second retention control unit core inside the shut-off module is also a state machine, which can be specifically shown with reference to FIG. 5.

After the shut-off module has been powered on and working for a certain period of time, it can receive a power-off request sent by the always-on power management unit. Based on the power-off request, it can be determined whether data need to be saved. When data need to be saved, the to-be-stored data are obtained from the second retention memory, and a data saving request is generated based on the to-be-stored data. The data saving request is sent to the always-on power management unit, so that the to-be-stored data are centrally stored in the first retention memory of the always-on power management unit.

In step S406, in response to powering on again, data sent by the always-on power management unit are received. The data are sent by the always-on power management unit in response to receiving a data restore signal.

The data restore process of the shut-off module is a passive response to the control of the always-on power management unit. The shut-off module only needs to passively and unconditionally complete the reception and response of the restore data without any other special processing.

In some optional embodiments, after receiving the power-off request sent by the always-on power management unit, the method further includes: entering a saving judgement state, and determining whether it is necessary to store the to-be-stored data in the always-on power management unit before powering off; on a condition that it is not necessary to store the to-be-stored data in the always-on power management unit, jumping to a second default state; and on a condition that it is necessary to store the to-be-stored data in the always-on power management unit, jumping to the second saving state. In the second default state, the power-off module is configured to receive a power-off request sent by the always-on power management unit. Determining the to-be-stored data based on the power-off request includes determining the to-be-stored data in the second saving state.

The second default state is the state of each shut-off module after the system is started, which can also be an idle state. In the second default state, the shut-off module waits to receive a power-off request (preq's negedge) sent by the always-on power management unit. After receiving the power-off request, the shut-off module will jump to the saving judgement state SAVE_JUDGE.

In the saving judgement state SAVE_JUDGE, the shut-off module will determine whether it is necessary to store the data in the always-on power management unit PMU before the power-off process based on its own present task context. If the determination result is fail, indicating that storage is unnecessary, the shut-off module will return to the second default state IDLE. If the determination result is pass, indicating that storage is necessary,, the shut-off module will jump to the second saving state SAVE.

In some optional embodiments, whether it is necessary to store data in the always-on power management unit PMU before the power-off process is determined based on the value of state register generated inside the shut-off module, and the value is autonomously configured by the shut-off module based on the specific scenario of the present task.

In the second saving state SAVE, the shut-off module starts to send a data saving request to the always-on power management unit PMU, and the always-on power management unit PMU starts to save data based on the state machine described in the previous section.

In some optional embodiments, the method further includes: on a condition that the shut-off module operates normally, storing intermediate data generated by the shut-off module in a local second retention memory, reading stored intermediate data from the second retention memory, and processing the intermediate data.

This embodiment is a process of shutting off the normal operation of the module. For example, its operation before the shut-off module is powered off, which is not specifically limited here.

On a condition that the shut-off module operates normally, the intermediate data generated during operating can be stored in the second retention memory to facilitate data retention during power-on and power-off. During normal operation, if intermediate data are required, the data can be read directly from this memory section. It should be noted that the second retention control unit may also determine whether the shut-off module needs to save data, i.e., perform data retention when the power is turned off, based on whether data are stored in the second retention memory.

To facilitate understanding, a complete implementation example of the workflow of retention path is provided. For convenience, the states in the state machine of the always-on power management unit PMU are referred to as PMU_IDLE, PMU_SAVE, PMU_DREADY, and PMU_RESTORE, and states in the state machine of the shut-off module are referred to as PSO_IDLE, PSO_SAVE_JUDGE, and PSO_SAVE, and it is assumed that the shut-off module is in a power-off state after the chip is started.

In the embodiment, the workflow of the path is described starting from chip startup.

A. After the entire chip is powered on and reset, the state machine of the always-on power management unit PMU is in the PMU_IDLE state. For the module that is turned off after the default chip is started, when it is powered on for the first time, the always-on power management unit PMU will automatically skip this meaningless data restore process.

B. Subsequently, when the shut-off module is ready to power off after running for a period of time, the shut-off module receives a power-off request preq_negedge from the always-on power management unit PMU, and the shut-off module enters the PSO_SAVE_JUDGE state. In the state, the shut-off module will check whether it needs to store data in the always-on power management unit PMU through the retention path. If it does not need, the shut-off module jumps back to PSO_IDLE state, otherwise the shut-off module jumps to PSO_SAVE state.

If the shut-off module jumps to the PSO_SAVE state, the shut-off module starts to initiate a data saving request for this round to the always-on power management unit PMU. After receiving the data saving request, the always-on power management unit PMU will first determine whether the data saving request is a single transmission. If the data saving request is a single transmission, the always-on power management unit PMU will jump from PMU_IDLE state to PMU_DREADY state and complete this round of data storage. If the data saving request is not a single transmission, the always-on power management unit PMU will jump to PMU_SAVE state and start receiving multiple data saving requests transmitted by the shut-off module until the always-on power management unit PMU receives the last data saving request of this round, and its state will jump from PMU_SAVE state to PMU_DREADY state. At this time, after the shut-off module receives the response to the last data saving request sent to the always-on power management unit PMU, it jumps back to the PSO_IDLE state. At this point, the data save process of this round ends, and the shut-off module can continue the subsequent power-off process until the power-off process is completed.

If the shut-off module jumps back to the PSO_IDLE state directly, it means that the shut-off module has independently determined that it does not need to retain the data on the path. The result can be obtained that the shut-off module has not sent a data saving request to the always-on power management unit PMU during this power-off process. Then the state of the always-on power management unit PMU will remain unchanged in the PMU_IDLE state.

C. When the shut-off module needs to be awakened again, the always-on power management unit PMU will first restore the power, clock, isolation, reset and other states of the shut-off module to normal. Then the always-on power management unit PMU will receive a restore_start signal from itself. The data restore signal indicates that the shut-off module is ready and can start to determine whether to restore the data of the shut-off module.

Specifically, the always-on power management unit PMU is already in the PMU_DREADY state, i.e., it has undergone the data retention process during the last power-off process. Then it will jump to the PMU_RESTORE state and start this round of data restore until the always-on power management unit PMU receives the response to the last data restore request sent by itself (from the shut-off module). Then the always-on power management unit PMU jumps back to the PMU_IDLE state and starts waiting for the next data retention request from the shut-off module.

When the always-on power management unit PMU is in the PMU_IDLE state, it means that no data storage was performed when the last power-off module was powered off, so there is no need to restore data when powered on this time, and the data restore process is automatically skipped.

When the shut-off module defaults to be in the power-on state after the chip is started, the above process can start directly from B.

It should be understood that, although the steps in the flowcharts involved in the above embodiments are displayed in sequence as indicated by the arrows, these steps are not necessarily executed in the order indicated by the arrows.

Unless otherwise specified herein, there is no strict order limitation for the execution of these steps, and these steps may be executed in other orders.

Moreover, at least a part of the steps in the flowcharts involved in the above embodiments may include multiple steps or multiple stages. These steps or stages are not necessarily executed at the same time, but can be executed at different times. The execution order of these steps or stages is not necessarily sequential, but can be executed in turn or alternately with other steps or at least part of the steps or stages in other steps.

A person of ordinary skill in the art can understand that all or part of the processes in the above-mentioned embodiment methods can be implemented by instructing related hardware through a computer program. The computer program can be stored in a non-transitory computer-readable storage medium. When the computer program is executed, it can include the processes of the embodiments of the above-mentioned methods.

Any reference to a memory, a database, or other medium used in the embodiments provided in the present disclosure may include at least one of a non-transitory memory and a transitory memory.

The non-transitory memory may include read-only memory (ROM), magnetic tape, floppy disk, flash memory, optical storage, high-density embedded non-transitory memory, resistive random access memory (ReRAM), magnetoresistive random access memory (MRAM), ferroelectric random access memory (FRAM), phase change memory (PCM), graphene memory, etc.

The transitory memory may include random access memory (RAM) or external cache memory, etc.

By way of illustration and not limitation, RAM may be in various forms, such as Static Random Access Memory (SRAM) or Dynamic Random Access Memory (DRAM).

The database involved in each embodiment provided in the present disclosure may include at least one of a relational database and a non-relational database.

Non-relational databases may include, but are not limited to, distributed databases based on blockchain.

The processor involved in each embodiment provided in the present disclosure may be a general-purpose processor, a central processing unit, a graphics processor, a digital signal processor, a programmable logic device, a data processing logic device based on quantum computing, an artificial intelligence (AI) processor, etc., but is not limited thereto.

The technical features of the above embodiments can be randomly combined. To simplify the description, not all possible combinations of the technical features in the above embodiments are described. However, as long as there is no contradiction in the combination of these technical features, all the combinations should be considered to be included within the scope of the present disclosure.

The above-described embodiments only illustrate several embodiments of the present disclosure, and the descriptions of which are relatively specific and detailed, but should not be construed as limiting the scope of the patent disclosure.

It should be noted that, for those of ordinary skill in the art, several modifications and improvements can be made without departing from the concept of the present disclosure, and these all fall within the protection scope of the present disclosure.

Therefore, the protection scope of the present disclosure should be determined by the appended claims.

What is claimed is:

1. A method for data retention during power gating, applied to an always-on power management unit, the method comprising:
sending a power-off request to a shut-off module, wherein the power-off request is configured to instruct the shut-off module to return to-be-stored data;
receiving a data saving request sent by each shut-off module, and centrally storing the to-be-stored data carried by each data saving request in a first retention memory; and
in response to receiving a data restore signal, returning data stored in the first retention memory to a corresponding shut-off module, wherein the data restore signal is generated after the shut-off module is powered on again.

2. The method according to claim 1, the method further comprising:
on a condition that a chip is powered on and reset, entering a first default state; and
in the first default state, only receiving the data saving request sent by the shut-off module, and ignoring the data restore signal.

3. The method according to claim 1, wherein receiving the data saving request sent by each shut-off module, and centrally storing the to-be-stored data carried by each data saving request in the first retention memory comprises:
receiving the data saving request sent by the shut-off module, and determining whether the data saving request is a last transmission request;
in response to determining that the data saving request is the last transmission request, centrally storing the to-be-stored data carried by the data saving request in the first retention memory, and entering a preparation state, wherein in the preparation state, the always-on power management unit is configured to wait for the data restore signal; and
in response to determining that the data saving request is not the last transmission request, centrally storing the to-be-stored data carried by the data saving request in the first retention memory, entering a first saving state, and continuing to receive a next data saving request sent by the shut-off module, until a data saving request is the last transmission request, and then entering the preparation state, wherein in the first saving state, the always-on power management unit is configured to receive the data saving request sent by the shut-off module.

4. The method according to claim 3, wherein in response to receiving the data restore signal, returning the data stored in the first retention memory to the corresponding shut-off module comprises:
in response to receiving the data restore signal and being in a preparation state, and data returned to the shut-off module not being last data, returning the stored data to the corresponding shut-off module; and
in response to receiving the data restore signal and being in a preparation state, and data returned to the shut-off module being last data, entering a first default state; and
wherein the method further comprises:
in response to receiving the data restore signal and being in the first default state, ignoring the data restore signal.

5. A method for data retention during power gating, applied to a shut-off module, the method comprising:
receiving a power-off request sent by an always-on power management unit;
determining to-be-stored data based on the power-off request, generating a data saving request based on the to-be-stored data, and sending the data saving request to the always-on power management unit, wherein the data saving request is configured to instruct the always-on power management unit to centrally store the to-be-stored data in a first retention memory;
in response to powering on again, receiving data sent by the always-on power management unit, wherein the data are sent by the always-on power management unit in response to receiving a data restore signal.

6. The method according to claim 5, wherein after receiving the power-off request sent by the always-on power management unit, the method further comprises:
entering a saving judgement state and determining whether it is necessary to store the to-be-stored data in the always-on power management unit before powering off;
on a condition that it is not necessary to store the to-be-stored data in the always-on power management unit, jumping to a second default state, wherein in the second default state, the power-off module is configured to receive the power-off request sent by the always-on power management unit; and
on a condition that the to-be-stored data need to be stored in the always-on power management unit, jumping to the second saving state; and
wherein determining the to-be-stored data based on the power-off request comprises:
in the second saving state, determining the to-be-stored data.

7. The method according to claim 5, wherein the method further comprises:
on a condition that the shut-off module operates normally, storing intermediate data generated by the shut-off module in a local second retention memory, and reading stored intermediate data from the second retention memory and processing the intermediate data.

8. A system for data retention during power gating, comprising: an always-on power management unit and at least one shut-off module,
wherein the always-on power management unit is configured to perform a method for data retention during power gating, and the method comprises:
sending a power-off request to a shut-off module, wherein the power-off request is configured to instruct the shut-off module to return to-be-stored data;
receiving a data saving request sent by each shut-off module, and centrally storing the to-be-stored data carried by each data saving request in a first retention memory; and
in response to receiving a data restore signal, returning data stored in the first retention memory to a corresponding shut-off module, wherein the data restore signal is generated after the shut-off module is powered on again.

9. The system according to claim 8, wherein the method further comprising:
on a condition that a chip is powered on and reset, entering a first default state; and
in the first default state, only receiving the data saving request sent by the shut-off module, and ignoring the data restore signal.

10. The system according to claim 8, wherein receiving the data saving request sent by each shut-off module, and centrally storing the to-be-stored data carried by each data saving request in the first retention memory comprises:
receiving the data saving request sent by the shut-off module, and determining whether the data saving request is a last transmission request;
in response to determining that the data saving request is the last transmission request, centrally storing the to-be-stored data carried by the data saving request in the first retention memory, and entering a preparation state, wherein in the preparation state, the always-on power management unit is configured to wait for the data restore signal; and
in response to determining that the data saving request is not the last transmission request, centrally storing the to-be-stored data carried by the data saving request in the first retention memory, entering a first saving state, and continuing to receive a next data saving request sent by the shut-off module, until a data saving request is the last transmission request, and then entering the preparation state, wherein in the first saving state, the always-on power management unit is configured to receive the data saving request sent by the shut-off module.

11. The system according to claim 10, wherein in response to receiving the data restore signal, returning the data stored in the first retention memory to the corresponding shut-off module comprises:
in response to receiving the data restore signal and being in a preparation state, and data returned to the shut-off module not being last data, returning the stored data to the corresponding shut-off module; and
in response to receiving the data restore signal and being in a preparation state, and data returned to the shut-off module being last data, entering a first default state; and
wherein the method further comprises:
in response to receiving the data restore signal and being in the first default state, ignoring the data restore signal.

12. The system according to claim 8, wherein the always-on power management unit comprises:
a first retention memory configured to centrally store the to-be-stored data sent by each shut-off module; and
a first retention control unit configured to store the to-be-stored data sent by each shut-off module in the first retention memory, read data from the first retention memory, and transmit the read data to a corresponding powered-on shut-off module.

13. The system according to claim 12, wherein the first retention memory comprises a first register and a first SRAM.

14. The system according to claim 13, wherein the first register is a non-retention register, and the first SRAM is a non-low-power consumption SRAM.

15. The system according to claim 12, wherein the always-on power management unit comprises a local clock, which is a working clock of the first retention memory and the first retention control unit, and the local clock is turned off on a condition that there is no storage of to-be-stored data and data restore.

16. The system according to claim 12, wherein the shut-off module comprises:
a normal operation unit configured to control normal operation of the shut-off module; and
a second retention control unit, comprising a second retention memory, configured to store the to-be-stored data generated by the normal operation unit on a condition that the shut-off module operates normally, and provide data stored in the second retention memory for the normal operation unit to read, wherein
the second retention control unit is further configured to establish a communication path with the first retention control unit, and store and read the to-be-stored data via the communication path.

17. The system according to claim 16, wherein the communication path comprises at least one of an existing setup path and a retention path,
the existing setup path is an existing path for configuring configuration information of the shut-off module, and
the retention path is configured to:
send a power-off preparation request sent by the first retention control unit to the second retention control unit;
in the process of storing to-be-stored data, send the to-be-stored data sent by the second retention control unit to the first retention control unit; and
in the process of data restore, send the data sent by the first retention control unit to the second retention control unit.

18. The system according to claim 17, wherein the retention path is an asynchronous transmission path.

19. The system according to claim 18, wherein the second retention memory comprises a second register and a second SRAM.

20. The system according to claim 19, wherein the second register is a non-retention register, and the second SRAM is a non-low-power consumption SRAM.
